(19) United States
(12) Patent Application Publication
(10) Pub. No.: US 2014/0129149 A1
(43) Pub. Date: May 8, 2014

(54) Formation Evaluation Using Hybrid Well Log Datasets

(71) Applicant: SCHLUMBERGER TECHNOLOGY CORPORATION, Sugar Land, TX (US)

(72) Inventors: Kais B. M. Gzara, Tunis (TN); Vikas Jain, Delhi (IN)

(73) Assignee: SCHLUMBERGER TECHNOLOGY CORPORATION, Sugar Land, TX (US)

(21) Appl. No.: 13/794,256

(22) Filed: Mar. 11, 2013

Related U.S. Application Data
(60) Provisional application No. 61/721,986, filed on Nov. 2, 2012.

(51) Int. Cl. G01V 9/00; G06F 17/00

(52) U.S. Cl. CPC G01V 9/00; G06F 17/00
USPC 702/11

(57) ABSTRACT

A method for determining at least one characteristic of a geological formation having a borehole therein may include collecting first and second dataset snapshots of the geological formation from the borehole. The method may further include generating a differential dataset based upon the first and second dataset snapshots, determining a multi-dimensional space based upon the differential dataset, and generating a first hybrid dataset based upon the first dataset snapshot by projecting the measurement data from the first dataset snapshot parallel to the multi-dimensional space and onto a complementary multi-dimensional space not parallel to the multi-dimensional space. A second hybrid dataset may also be generated based upon the second dataset snapshot by projecting the measurement data from the second dataset snapshot parallel to the same multi-dimensional space and onto the same complementary multi-dimensional space, and the characteristic(s) associated with the geological formation may be determined based upon the first and second hybrid datasets.

### CROSS-REFERENCE TO RELATED APPLICATION

This application claims priority to and the benefit of U.S. Provisional Patent Application Ser. No. 61/721,986, filed Nov. 2, 2012, and entitled “FORMATION EVALUATION USING HYBRID WELL LOG DATASETS,” the disclosure of which is incorporated by reference herein in its entirety.

### BACKGROUND

Logging tools may be used in wellbores to make, for example, formation evaluation measurements to infer properties of the formations surrounding the borehole and the fluids in the formations. Common logging tools include electromagnetic tools, acoustic tools, nuclear tools, and nuclear magnetic resonance (NMR) tools, though various other tool types are also used.

Early logging tools were run into a wellbore on a wireline cable, after the wellbore had been drilled. Modern versions of such wireline tools are still used extensively. However, the desire for real-time or near real-time information while drilling the borehole gave rise to measurement-while-drilling (MWD) tools and logging-while-drilling (LWD) tools. By collecting and processing such information during the drilling process, the driller may modify or correct well operations to optimize drilling performance and/or well trajectory.

MWD tools typically provide drilling parameter information such as weight-on-bit, torque, shock & vibration, temperature, pressure, rotations-per-minute (rpm), mud flow rate, direction, and inclination. LWD tools typically provide formation evaluation measurements such as natural or spectral gamma-ray, resistivity, dielectric, sonic velocity, density, photoelectric factor, neutron porosity, sigma thermal neutron capture cross-section, a variety of neutron induced gamma-ray spectra, and NMR distributions. MWD and LWD tools often have components common to wireline tools (e.g., transmitting and receiving antennas or sensors in general), but MWD and LWD tools may be constructed to endure and operate in the harsh environment of drilling. The terms MWD and LWD are often used interchangeably, and the use of either term in this disclosure will be understood to include both the collection of formation and wellbore information, as well as data on movement and placement of the drilling assembly.

Logging tools may be used to determine formation volumetrics, that is, quantify the volumetric fraction, typically expressed as a percentage, of each constituent present in a given sample of formation under study. Formation volumetrics involves the identification of the constituents present, and the assigning of unique signatures for constituents on different log measurements. When, using a corresponding earth model, the forward model responses of the individual constituents are calibrated, the log measurements may be converted to volumetric fractions of constituents.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method for determining at least one characteristic of a geological formation having a borehole therein may include collecting first and second dataset snapshots of the geological formation from the borehole, where each of the first and second dataset snapshots includes measurement data for a plurality of different measurement types. The method may further include generating a differential dataset based upon the first and second dataset snapshots, determining a multi-dimensional space based upon the differential dataset, and generating a first hybrid dataset based upon the first dataset snapshot by projecting the measurement data from the first dataset snapshot parallel to the multi-dimensional space and onto a complementary multi-dimensional space not parallel to the multi-dimensional space. A second hybrid dataset may also be generated based upon the second dataset snapshot by projecting the measurement data from the second dataset snapshot parallel to the same multi-dimensional space and onto the same complementary multi-dimensional space. The method may further include determining at least one characteristic associated with the geological formation based upon the first and second hybrid datasets.

A related well-logging system may include a well-logging tool to collect first and second dataset snapshots of a geological formation from a borehole therein, each of the first and second dataset snapshots having measurement data for a plurality of different measurement types. The system may further include a processor to generate a differential dataset based upon the first and second dataset snapshots, determine a multi-dimensional space based upon the differential dataset, generate a first hybrid dataset based upon the first dataset snapshot by projecting the measurement data from the first dataset snapshot parallel to the multi-dimensional space and onto a complementary multi-dimensional space not parallel to the multi-dimensional space, and generate a second hybrid dataset based upon the second dataset snapshot by projecting the measurement data from the second dataset snapshot parallel to the multi-dimensional space and onto the complementary multi-dimensional space. The processor may further determine at least one characteristic associated with the geological formation based upon the first and second hybrid datasets.

A related non-transitory computer-readable medium may have computer executable instructions for causing a computer to generate a differential dataset based upon first and second dataset snapshots of a geological formation, where each of the first and second dataset snapshots includes measurement data for a plurality of different measurement types. The computer-executable instruction may also be for causing the computer to determine a multi-dimensional space based upon the differential dataset, generate a first hybrid dataset based upon the first dataset snapshot by projecting the measurement data from the first dataset snapshot parallel to the multi-dimensional space and onto a complementary multi-dimensional space not parallel to the multi-dimensional space, generate a second hybrid dataset based upon the second dataset snapshot by projecting the measurement data from the second dataset snapshot parallel to the multi-dimensional space and onto the complementary multi-dimensional space, and determine at least one characteristic associated with the geological formation based upon the first and second hybrid datasets to evaluate the geological formation.

### BRIEF DESCRIPTION OF THE DRAWINGS

FIG. 1 is a schematic diagram of a well site system which may be used for implementation of an example embodiment.

FIGS. 2-7 are a series of multi-dimensional space diagrams illustrating an example approach for hybrid well log dataset generation and evaluation.

FIGS. 8A, 8B, and 8C are respective graphs of gamma-ray, neutron, and density measurements, along with corresponding projected dataset curves determined in accordance with an example embodiment.

FIG. 9 is a flow diagram illustrating example aspects of a method for determining geological formation characteristics in accordance with an example embodiment.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout.

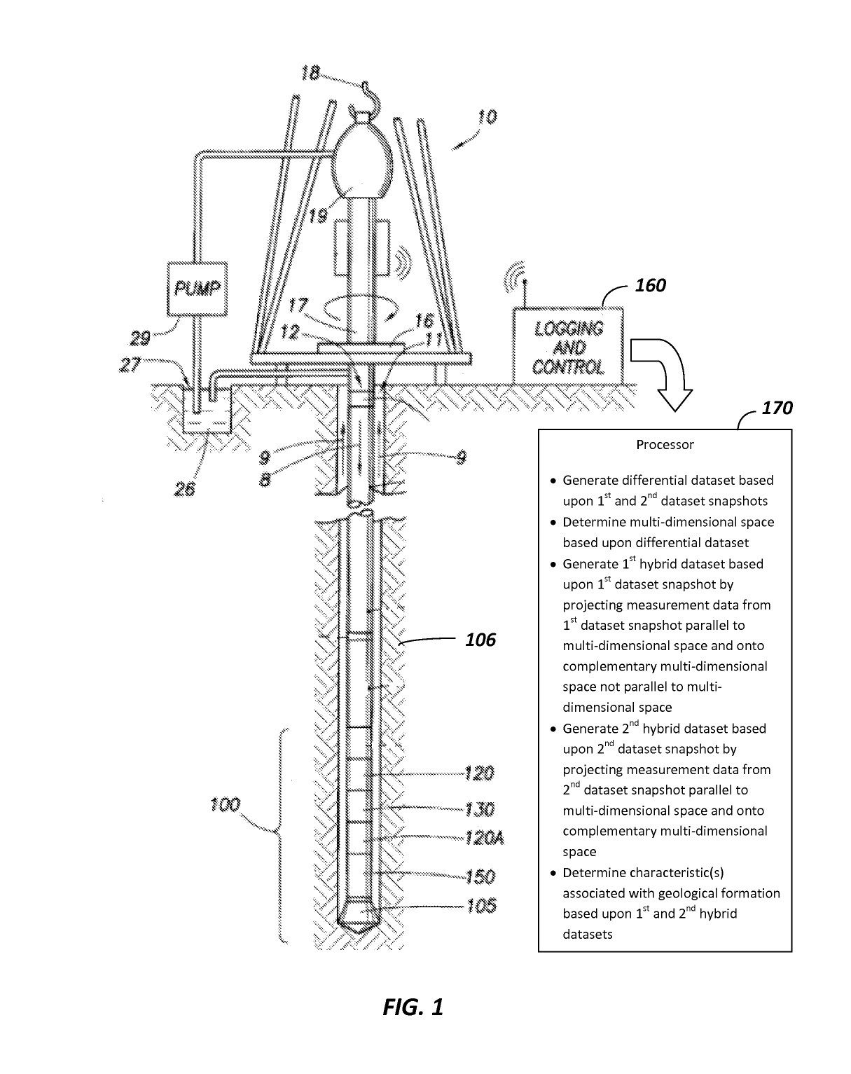

Referring initially to FIG. 1, a well site system which may be used for implementation of the example embodiments set forth herein is first described. The well site may be onshore or offshore. In this example system, a borehole 11 is formed in subsurface formations 106 by rotary drilling. Embodiments of the disclosure may also use directional drilling, for example.

A drill string 12 is suspended within the borehole 11 and has a bottom hole assembly 100 which includes a drill bit 105 at its lower end. The surface system includes a platform and derrick assembly 10 positioned over the borehole 11, the assembly 10 including a rotary table 16, Kelly 17, hook 18 and rotary swivel 19. The drill string 12 is rotated by the rotary table 16, which engages the Kelly 17 at the upper end of the drill string. The drill string 12 is suspended from a hook 18, attached to a travelling block (not shown), through the Kelly 17 and a rotary swivel 19 which permits rotation of the drill string relative to the hook. A top drive system may also be used in some embodiments.

In the illustrated example, the surface system further illustratively includes drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole 11, as indicated by the directional arrows 9. The drilling fluid lubricates the drill bit 105 and carries formation 106 cuttings up to the surface as it is returned to the pit 27 for recirculation.

In various embodiments, the systems and methods disclosed herein may be used with other conveyance approaches known to those of ordinary skill in the art. For example, the systems and methods disclosed herein may be used with tools or other electronics conveyed by wireline, slickline, drill pipe conveyance, coiled tubing drilling, and/or a while-drilling conveyance interface. For example purposes, FIG. 1 shows a while-drilling interface. However, systems and methods disclosed herein could apply equally to wireline or other suitable conveyance platforms. The bottom hole assembly 100 of the illustrated embodiment includes a logging-while-drilling (LWD) module 120, a measuring-while-drilling (MWD) module 130, a rotary-steerable system and motor, and drill bit 105.

The LWD module 120 is housed in a drill collar and may include one or a more types of logging tools. It will also be understood that more than one LWD and/or MWD module may be used, e.g. as represented at 120A. (References, throughout, to a module at the position of 120 may also mean a module at the position of 120A as well.) The LWD module may include capabilities for measuring, processing, and storing information, as well as for communicating with the surface equipment, such as the illustrated logging and control station 160. By way of example, the LWD module may include one or more of an electromagnetic device, acoustic device, nuclear magnetic resonance device, nuclear measurement device (e.g. gamma-ray, density, photoelectric factor, sigma thermal neutron capture cross-section, neutron porosity), etc., although other measurement devices may also be used.

The MWD module 130 is also housed in a drill collar and may include one or more devices for measuring characteristics of the drill string and drill bit. The MWD tool may further include an apparatus for generating electrical power to the downhole system (not shown). This may typically include a mud turbine generator powered by the flow of the drilling fluid, it being understood that other power and/or battery systems may be employed. The MWD module may also include one or more of the following types of measuring devices: a weight-on-bit measuring device, a torque measuring device, a shock and vibration measuring device, a temperature measuring device, a pressure measuring device, a rotations-per-minute measuring device, a mud flow rate measuring device, a direction measuring device, and an inclination measuring device.

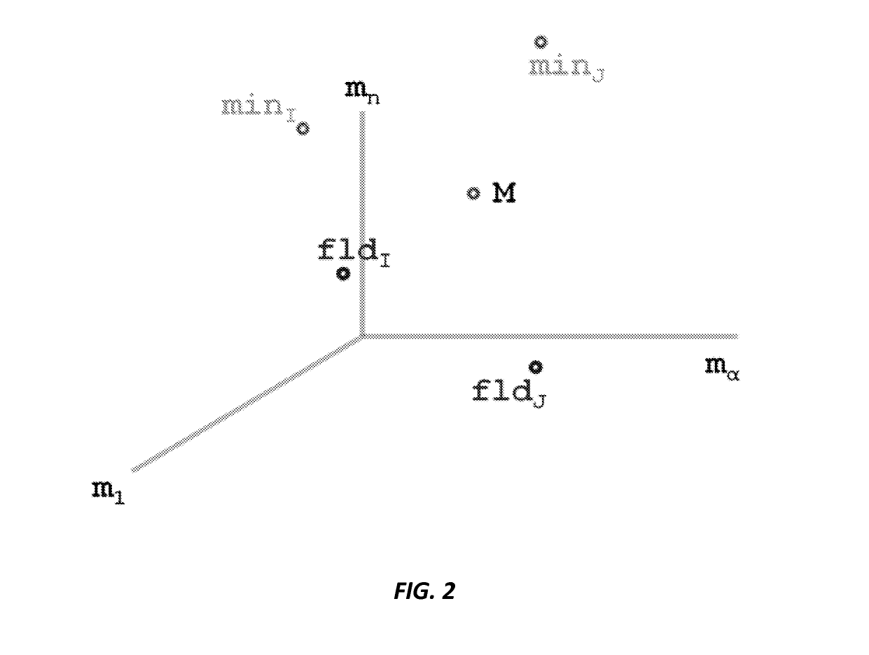

The above-described borehole tools may be used for collecting measurements of the geological formation adjacent the borehole 11 to determine one or more characteristics of the geological formation in accordance with example embodiments, which will now be described with reference to FIGS. 2-6. A processor 170 may be used for determining such characteristics. The processor 170 may be implemented using a combination of hardware (e.g., microprocessor, etc.) and a non-transitory medium having computer-executable instructions for performing the various operations described herein. It should be noted that the processor 170 may be located at the well site, or it may be remotely located.

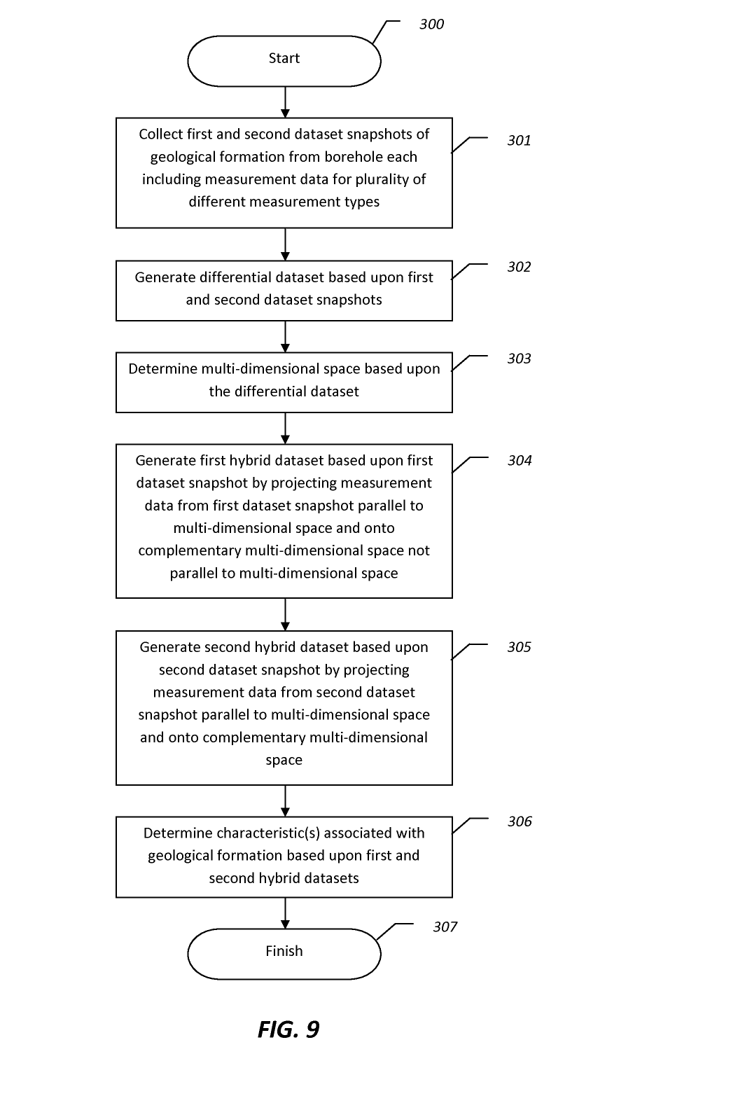

Various operations performed by the processor 170 are now generally described with reference to FIG. 9, and will be described in greater detail below. Beginning at Block 300, first and second dataset snapshots of the geological formation 106 may be collected from the borehole 11, as described above, where each of the first and second dataset snapshots includes measurement data for a plurality of different measurement types (Block 301). The method may further include generating a differential dataset based upon the first and second dataset snapshots, at Block 302, and determining a multi-dimensional space based upon the differential dataset, at Block 303. A first hybrid dataset may be generated based upon the first dataset snapshot by projecting the measurement data from the first dataset snapshot parallel to the multi-dimensional space and onto a complementary multi-dimensional space not parallel to the multi-dimensional space, at Block 304. A second hybrid dataset may also be generated based upon the second dataset snapshot by projecting the measurement data from the second dataset snapshot parallel to the same multi-dimensional space and onto the same complementary multi-dimensional space, at Block 305. The method further illustratively includes determining at least one characteristic associated with the geological formation based upon the first and second hybrid datasets, at Block 306, which concludes the method illustrated in FIG. 9 (Block 307).

By way of background, during formation evaluation, underground formations are typically broken down into individual constituents or building blocks. These constituents are generally of two types, namely minerals making up the rock and fluids filling up the porosity. Each one of these constituents, has specific gamma-ray, density, neutron, etc., measurement values associated therewith. Considering gamma-ray, density, and neutron measurement types as different axes in space (respectively called m₁, m_{α}, mₙ in the illustrated examples), then each one of these mineral and fluid constituents will have a specific point associated with it in this space. The coordinates of this point will be the specific gamma-ray, density, neutron (and so on) values corresponding to the constituent. These points are also referred to in the art of formation evaluation as constituent “end-points”.

In FIG. 2, an example of four constituents is shown, namely two minerals (min_{I}, min_{J}) plus two fluids (fld_{I}, fld_{J}). Also shown is an additional point M, coordinates of which represents the actual measured gamma-ray, density, neutron (and so on) values, corresponding in practice to the four constituents mentioned above, which are present in the geological formation in certain proportions, at a given depth.

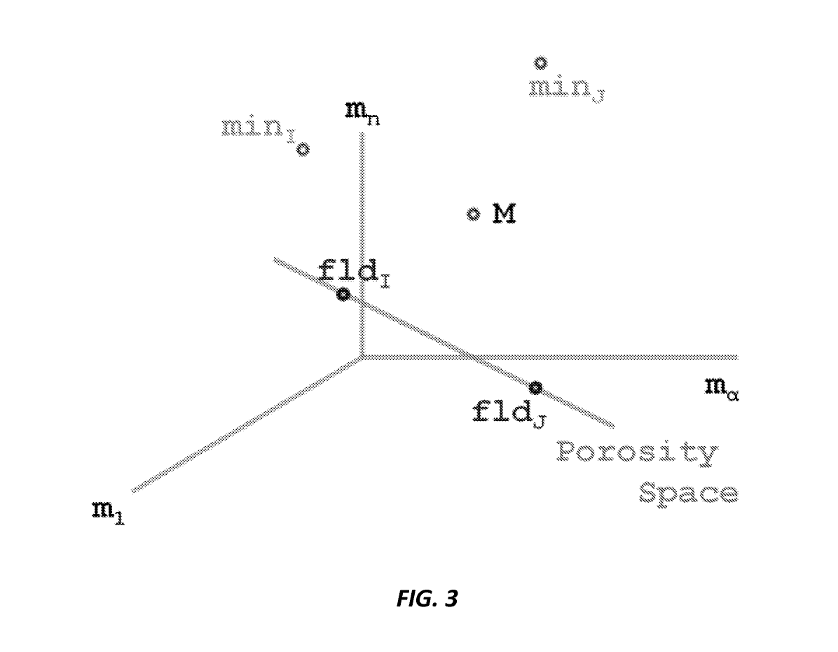

When the constituents' end-points are known, then each M point may be reconstructed as a function of the four constituents' end-points mentioned (in the example above), in different proportions (see FIG. 3). However, challenges may arise when some of the constituents' end-points are not known. This is often the case in gas-bearing formations, certain types of mud systems and corresponding mud filtrate, or in the case of chemical reactions or phase changes taking place in situ and transforming some constituents into other constituents.

The present evaluation approach may help characterize the underground formation without a priori knowledge of each constituent present in the formation. In the case of formation porosity, for example, Applicants theorize without wishing to be bound thereto that it is not the exact position of the fluid end-points that are of primary interest, but rather the position of the line joining the two fluid constituents in the case of the illustrated example, which is referred to as “Porosity Space” in the present description.

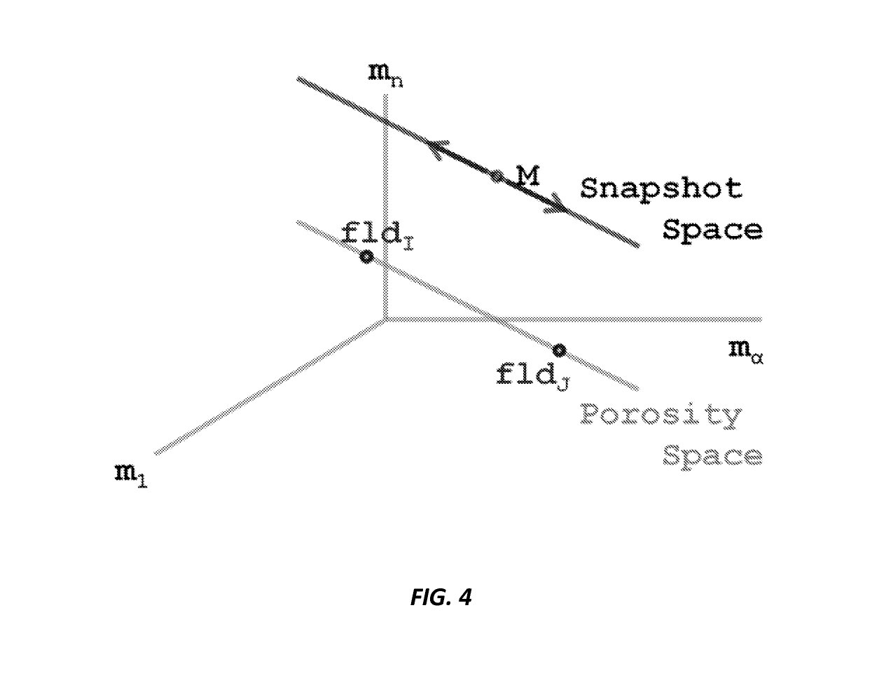

More particularly, the position of the above-noted line may be inferred from taking two (or more) different “snapshots” of the same formation, with just the fluid mixture changing in between the two snapshots. In practice, these two different snapshots may be achieved by logging the formation at different times (e.g., allowing invasion to progress in between), or at different depths-of-investigation, thereby sampling the underground formation with a different invasion status. This is because different snapshots will align along a direction identical to the “Porosity Space” in the illustrated example (FIG. 4).

The example approach may take advantage of multiple snapshots of the same formation to provide a new class of log measurements that do not depend on the considered snapshot, i.e. which are “snapshot invariant” (or “time independent”). By constructing such a class of log measurements, this class of log measurements then treats the different fluid constituents equally. This may also be re-expressed to say that the different fluids present would now have the same end-points, from the perspective of the newly constructed log measurements.

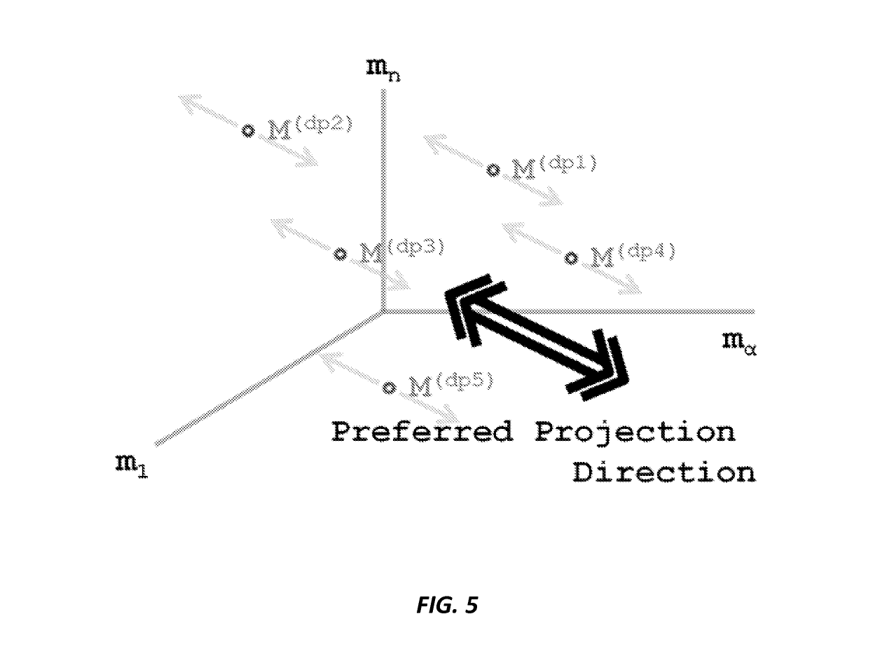

Referring now to FIG. 5, different points “M” are provided corresponding to different measurements made at different depths along the well. More particularly, the notations dp1, dp2, dp3 and so on, correspond to depth position no. 1, depth position no. 2, depth position no. 3, etc. The arrows around the different points M show how M would move in between different snapshots as we continue to consider the above example of two minerals plus two fluids, and the fluid mixture composition changing in between snapshots.

A large double arrow is also shown in FIG. 5 to represent the predominant or prevalent direction of change in between snapshots, as revealed through time-lapse or multiple-depth-of-investigation (MDOI) data acquisition, for example, as discussed above.

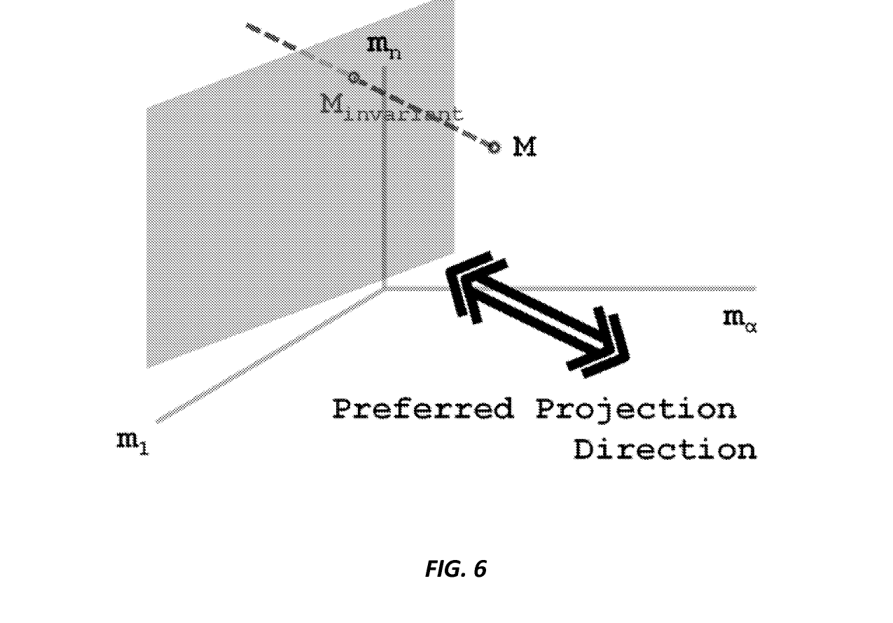

Referring now to FIG. 6, if the M data points are projected parallel to the large arrow, then by nature of the geometrical construction a new point Mᵢₙᵥₐᵣᵢₐₙₜ is provided, the coordinates of which are new hybrid log measurements. The new hybrid log measurements will not depend on the considered snapshot. More particularly, the expression “hybrid log measurement” is used herein to mean a new log measurement that is a combination of the original log measurements. Also, it should be noted that the “Projection Direction” is unique, however the plane on which the data is projected may be selected in different ways.

It should also be noted that the above-described example was directed to two minerals plus two fluids, which thus provides for a three-dimensional space. However, more constituents may be considered, as well as more measurements, in which case the desired projection direction would become a plane (or “bigger”) instead of just a straight line, and the mathematical relationships would apply in a similar fashion but for additional dimensions, as will be appreciated by those skilled in the art.

The invariant hybrid measurements may be used for determining various characteristics of the associated geological formation. One example is to generally provide a correction in porosity measurements. However, the composition of the matrix (i.e. the solid skeleton of the formation), which typically includes minerals, may impact most of the log measurements in general. Thus, when solving for correct porosity, the mineralogy of the matrix may not be available beforehand. Thus, the porosity correction in such case may be considered as solving for both the porosity and the mineralogy of the formation together.

Another example use case would be correct porosity and mineralogy in gas-bearing formations, irrespective of gas properties. Still another example use case would be to correct porosity and mineralogy in a formation drilled with unusual or unique mud systems, such as potassium-formate (K-formate) muds, irrespective of the mud filtrate properties. Another example use case may be to correct porosity and mineralogy where one of the constituents present may be melting (or freezing) or changing phase in general, with little or no insight into the properties of one or the other phase, or both phases. Yet another example use case would be to correct porosity and mineralogy, where salt originally plugging the porosity may be partially dissolving in invading water-based mud (WBM) filtrate, irrespective of the mixed or variable and unknown water salinity system present. Another example use case would be resistivity-independent water saturation in case of gas-bearing formations drilled with K-formate muds. A further example use case is for mixed or variable and unknown water salinity systems in general. That is, even if the porosity error may be considered small, other mixed water salinity approaches (such as the Resistivity/Sigma technique) may otherwise call for a relatively accurate porosity to be available beforehand.

To achieve the foregoing, current formation evaluation techniques and formulas may be adapted to use the hybrid log measurements mentioned above, i.e., the hybrid log measurements may be substituted for the original log measurements. By using the newly constructed hybrid log measurements, the fluid constituents whose properties are unknown, may then be dropped from the volumetric formation evaluation techniques and formulas considered, as the fluids would now effectively have the same end-points, as will be appreciated from the following example process.

More particularly, an example volumetric evaluation process may include taking a first snapshot of a geological formation (e.g. gamma-ray, density, neutron, etc., measurements). A second snapshot of the formation (e.g. additional gamma-ray, density, neutron, etc., measurements) is taken or collected either in time-lapse data acquisition fashion (i.e., after some time has passed), or in multiple-depth-of-investigation (MDOI) fashion.

The first and second snapshots may then be subtracted from each other. A statistical technique, such as Principal Component Analysis (PCA), for example, may then be applied to the resulting differential dataset to identify the dimensionality of the corresponding vector space (i.e. the number of principal factors that may account for the vast majority of the dataset). This dimensionality may correspond to the number of constituents that have substituted each other in between the two snapshots, minus one. It should be noted that the dimensionality may also be enforced by outside observations available beforehand, such as mud logging data, or educated assumptions, for example. Moreover, the PCA technique may be applied to the entire depth interval considered, or zone-by-zone, or in a sliding depth interval fashion.

The principal components resulting from the PCA analysis, which correspond to the selected number of substituted constituents, together provide a unique multi-dimensional space X to which it is desired to carry-out projections thereto. Accordingly, a first hybrid log dataset may be generated from the first snapshot by projecting the data points from the first snapshot parallel to X, which was characterized in the preceding operation, and onto a complementary user-defined space Y that is not parallel to X. Similarly, a second hybrid log dataset may be generated from the second snapshot by projecting the data points from the second snapshot parallel to the same X space, and onto the same complementary space Y.

It may then be confirmed that first and second hybrid log datasets are close to one another, within the statistical accuracy and precision available for the various measurements used, if desired. Furthermore, an average of the first and second hybrid log datasets may be computed. Moreover, a difference between the first and second hybrid log datasets may be computed, if desired, and statistical techniques may also be applied to assess or assign an error bar or range to the hybrid log datasets, if desired. Furthermore, the computed average hybrid logs may be input to a conventional formation evaluation technique to compute porosity and mineralogy in different scenarios, such as the example use cases set forth above.

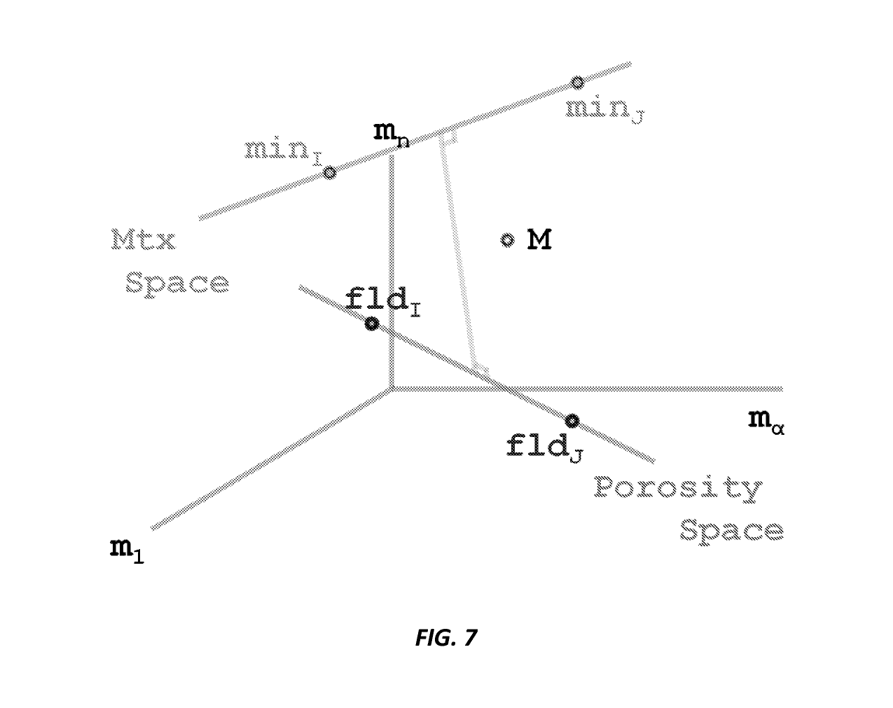

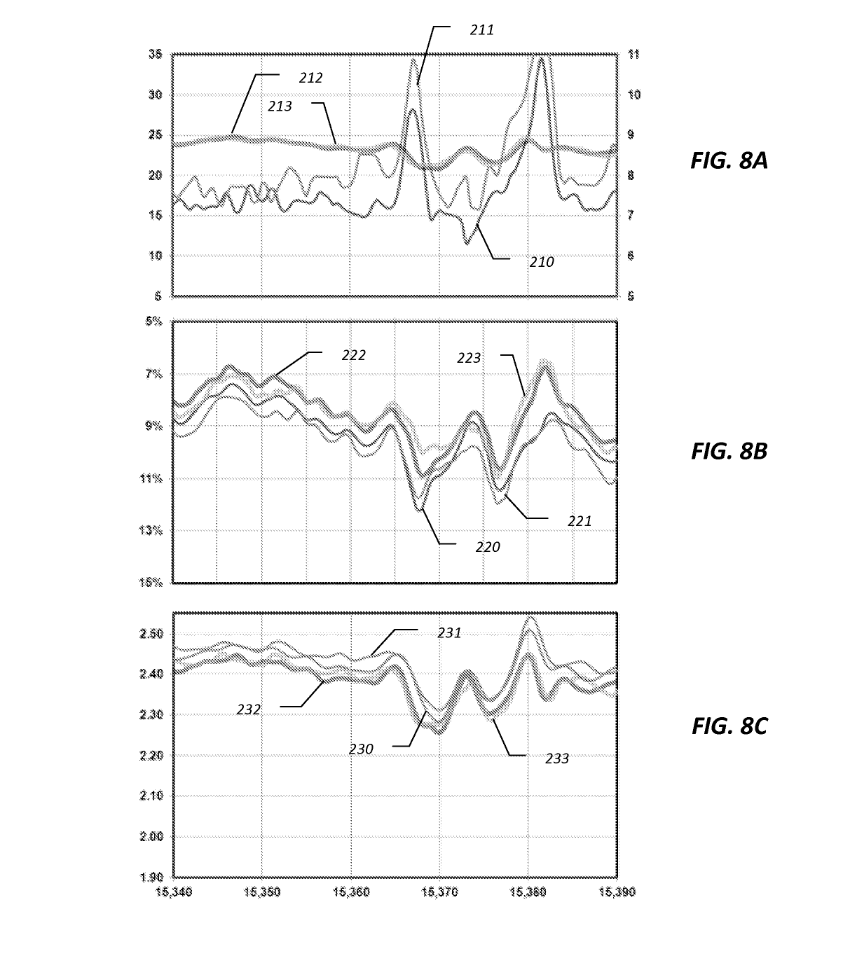

Referring additionally to FIGS. 7 and 8A-8C, further details of the above approach are now described. This description uses vector notation \vec{M}, corresponding to the effectively consonant measurements (i.e. measurements with measurement response volumes similarly affected by invasion) considered m₁ m₂ . . . m_{α} m_{β} . . . mₙ, and the notation \vec{M}¹ \vec{M}² . . . \vec{M}ⁱ \vec{M}^{j} . . . \vec{M}^{N} refers to the different states (or snapshots at different times) of the formation, whereas the different formation constituents log signatures are referred to as \vec{M}_{A} \vec{M}_{B} . . . \vec{M}_{I} \vec{M}_{J} \vec{M}_{Z}. Furthermore, \vec{M} is generically meant to represent \vec{M} itself, or any linear transformation thereof. Moreover, where the volume and log responses of some constituents are known a priori, the notation \vec{M} may also include such transformations that rid \vec{M} of these known constituents' contributions, to produce a “clean” \vec{M} vector that depends on the remaining unknowns alone.

The measurements m₁ m₂ . . . m_{α} m_{β} . . . mₙ, are taken to be unitless (or dimensionless), by normalizing the measurements to the quantum of noise inherently pervading each. First, this is done to remain above the noise level intrinsic to various measurements, and to avoid confounding noise with true information. Second, this is relevant when it comes to displaying the above discussed vectors or functions, on a neutral, or user-independent scale. Each \vec{M}ⁱ may then be expressed as a linear combination of the vectors \vec{M}_{I} (assuming measurements with linear mixing laws) as:

$${{M}^{}}^{j} = {\sum }_{I} {V}_{I}^{j} \cdot {{M}^{}}_{I}$$

A case of four formation constituents, including two matrix mineral constituents, and two porosity fluid constituents, is shown in FIG. 7. This diagram also shows what is referenced herein as “porosity subspace”, which is the space spanned by the porosity constituents (here, the line joining the fluid points fld_{I}, fld_{J}), and the “matrix subspace” (here, the line joining the mineral points min_{I}, min_{J}).

This approach seeks those affine transformations of \vec{M}—denoted here as A(\vec{M})=K(\vec{M})+U (with K (\vec{M}) being a linear transformation, and \vec{U} a constant vector)—such that the constituents filling up the porosity (typically fluids, but also other minerals that may be occluding the porosity, such as salt), have the same response. This response may be expressed mathematically as:

∀Fld_{I},Fld_{J}A(\vec{M}_{Fld}_{_{J}})=A(\vec{M}_{Fld}_{_{I}})

which may also be stated as:

∀Fld_{I},Fld_{J}K(\vec{M}_{Fld}_{_{J}}−\vec{M}_{Fld}_{_{I}})=\vec{0}

and this concerns those measurements m_{α} that display changes in-between different snapshots \vec{M}ⁱ and \vec{M}^{j}. One reason to seek these transformations is that expressions like

$${{M}^{}}^{j} = {\sum }_{I} {V}_{I}^{j} \cdot {{M}^{}}_{I}$$

rely on “\vec{M}_{I}” to be known to solve for “V_{I}ⁱ”. It should be noted that the expression:

$${{M}^{}}^{j} = {\sum }_{I} {V}_{I}^{j} \cdot {{M}^{}}_{I}$$

together with

$$1 = {\sum }_{I} {V}_{I}^{i}$$

is also typically referred to, as “n+1 equations for Z unknowns”, where n is the number of components of the vectors \vec{M} (and including the effectively consonant measurements considered m₁ m₂ . . . m_{α} m_{β} . . . mₙ). Z is the number of unknowns V_{I}ⁱ (with the different formation constituents indexed as A B . . . I J . . . Z).

Furthermore, the solution to this system of equations (for which n+1≧Z) is the general expression:

$$[ \begin{matrix}{V}_{A}^{i} \\ {V}_{B}^{i} \\ … \\ {V}_{I}^{i} \\ {V}_{I}^{i} \\ … \\ {V}_{Z}^{i}\end{matrix} ] [ {[ {}^{T} R \cdot {Cov}^{- 1} \cdot R ]}^{- 1} \cdot {}^{T} R \cdot {Cov}^{- 1} ] \cdot [ \begin{matrix}{{M}^{}}^{i} \\ 1\end{matrix} ]$$

where R is now the matrix:

$$[ \begin{matrix}{{M}^{}}_{A} & {{M}^{}}_{B} & … & {{M}^{}}_{I} & {{M}^{}}_{J} & … & {{M}^{}}_{Z} \\ 1 & 1 & … & 1 & 1 & … & 1\end{matrix} ]$$

and Cov is now the matrix:

$$[ \begin{matrix}{Cov}_{{M}^{}} & 0 \\ 0 & ɛ\end{matrix} ]$$

where Cov_{\vec{M}} is the covariance matrix of the measurements m₁ m₂ . . . m_{α} m_{β} . . . mₙ, and ∈ is a very small number as compared to the Eigen values of Cov_{\vec{M}}. For example, ∈ may be equal to 0 to enforce a sum of volumes=1 condition.

All of the \vec{M}_{I} may not be known. For example, this may be the case with gas-bearing formations, or where drilling mud filtrate characteristics are not straightforward, such as when using K-formate drilling muds. Yet, with this newly introduced transformation A, we can see that the expression:

$${{M}^{}}^{i} = {\sum }_{I} {V}_{I}^{i} \cdot {{M}^{}}_{I}$$

now results in a new expression:

$$\begin{matrix}A ( {{M}^{}}^{i} ) = {\sum }_{I} {V}_{I}^{i} \cdot A ( {{M}^{}}_{I} ) \\ = {\sum }_{I ∈ ϕ} {V}_{{Fld}_{I}}^{i} \cdot A ( {{M}^{}}_{{Fld}_{I}} ) + {\sum }_{J ∈ Mtx} {V}_{{Min}_{J}}^{i} \cdot A ( {{M}^{}}_{{Min}_{J}} ) \\ = ϕ \cdot A ( {{M}^{}}_{ϕ} ) + {\sum }_{J ∈ Mtx} {V}_{{Min}_{J}}^{i} \cdot A ( {{M}^{}}_{{Min}_{J}} )\end{matrix}$$

$$or$$

$$\begin{matrix}K ( {{M}^{}}^{i} ) = {\sum }_{I} {V}_{I}^{i} \cdot K ( {{M}^{}}_{I} ) \\ = {\sum }_{I ∈ ϕ} {V}_{{Fld}_{I}}^{i} \cdot K ( {{M}^{}}_{{Fld}_{I}} ) + {\sum }_{J ∈ Mtx} {V}_{{Min}_{J}}^{i} \cdot K ( {{M}^{}}_{{Min}_{J}} ) \\ = ϕ \cdot K ( {{M}^{}}_{ϕ} ) + {\sum }_{J ∈ Mtx} {V}_{{Min}_{J}}^{i} \cdot K ( {{M}^{}}_{{Min}_{J}} )\end{matrix}$$

where φ is the porosity, and K (\vec{M}_{φ}) now refers to a generic porosity constituent response. The covariance matrix is also propagated accordingly:

Cov_{K(\vec{M})}=K·Cov_{\vec{M}}·^{T}K

It will be appreciated that a goal of the transformation A is to get rid of the unknowns V_{Fld}_{_{I}}ⁱ, and replace them with a single unknown φ, where some of the \vec{M}_{Fld}_{_{I}} may not have been known, but A (\vec{M}_{φ}) or K (\vec{M}_{φ}) is known. The transformation A has effectively manufactured new hybrid measurements (A(\vec{M}))₁ (A(\vec{M}))₂ . . . (A(\vec{M}))_{α} (A(\vec{M}))_{β} . . . (A(\vec{M}))ₙ from the original measurements m₁ m₂ . . . m_{α} m_{β} . . . mₙ, which are now immune to changes in constituents volumes in between different snapshots. This results in a correspondingly lower rank of K, i.e., one less equation for one less unknown, two less equations for two less unknowns, three less equations for three less unknowns, etc.

Furthermore, when the matrix is known a priori, the above expression may be restated as:

A(\vec{M}ⁱ=φ·A(\vec{M}_{φ})+(1−φ)·A(\vec{M}_{Mtx})

or

K(\vec{M}ⁱ)=φ·K(\vec{M}_{φ})+(1−φ)·K(\vec{M}_{Mtx}),

which becomes

(A(\vec{M}ⁱ)−A(\vec{M}_{Mtx}))=φ·(A(\vec{M}_{φ})−A(\vec{M}_{Mtx}))

or

(K(\vec{M}ⁱ)−K(\vec{M}_{Mtx}))=φ·(K(\vec{M}_{φ})−K(\vec{M}_{Mtx})),

and the correct porosity φ may be solved in various ways, such as:

$$\begin{matrix}{ϕ}_{α} = \frac{{( A ( {{M}^{}}^{i} ) )}_{α} - {( A ( {{M}^{}}_{Mtx} ) )}_{α}}{{( A ( {{M}^{}}_{ϕ} ) )}_{α} - {( A ( {{M}^{}}_{Mtx} ) )}_{α}} \\ = \frac{{( K ( {{M}^{}}^{i} ) )}_{α} - {( K ( {{M}^{}}_{Mtx} ) )}_{α}}{{( K ( {{M}^{}}_{ϕ} ) )}_{α} - {( K ( {{M}^{}}_{Mtx} ) )}_{α}}\end{matrix}$$

This may depend on the component a of the vector A(\vec{M}_{φ}) or K(\vec{M}), used to solve for φ. Depending on whether n+1=Z or n+1>Z, there would be a single solution or multiple solutions, respectively. In the case where multiple solutions are possible (i.e., in the case when the system of equations is “over-determined”), we may invoke the covariance matrix, and the representative porosity φ would result from:

$$ϕ = [ {{[}^{T} ( K ( {{M}^{}}_{ϕ} - {{M}^{}}_{Mtx} ) ) \cdot {( K \cdot {Cov}_{{M}^{}} \cdot {}^{T} K )}^{- 1} \cdot ( K ( {{M}^{}}_{ϕ} - {{M}^{}}_{Mtx} ) ) ]}^{- 1} \cdot {}^{T} ( K ( {{M}^{}}_{ϕ} - {{M}^{}}_{Mtx} ) ) \cdot {( K \cdot {Cov}_{{M}^{}} \cdot {}^{T} K )}^{- 1} ] \cdot ( K ( {{M}^{}}^{i} - {{M}^{}}_{Mtx} ) )$$

Although the above equation for the porosity allows for computation of porosity in the event of an over-determined system of equations, other approximations are also possible. One such approximation will be described below, as we discuss how two lines which do not intersect in three-dimensional space may be approximated to intersect.

Even when the matrix is not known, an apparent porosity may be computed by assuming a certain matrix type. This may be a predominant mineral encountered, e.g., limestone. This newly defined apparent porosity will be independent of fluid type, according to:

$${ϕ}_{Lim}^{app} = [ {{[}^{T} ( K ( {{M}^{}}_{ϕ} - {{M}^{}}_{Lim} ) ) \cdot {( K \cdot {Cov}_{{M}^{}} \cdot {}^{T} K )}^{- 1} \cdot ( K ( {{M}^{}}_{ϕ} - {{M}^{}}_{Lim} ) ) ]}^{- 1} \cdot {}^{T} ( K ( {{M}^{}}_{ϕ} - {{M}^{}}_{Lim} ) ) \cdot {( K \cdot {Cov}_{{M}^{}} \cdot {}^{T} K )}^{- 1} ] \cdot ( K ( {{M}^{}}^{i} - {{M}^{}}_{Lim} ) )$$

in which case the below expression now results for the correct porosity:

$$ϕ = \frac{{ϕ}_{Lim}^{app .} ( {{M}^{}}^{i} ) - {ϕ}_{Lim}^{app .} ( {{M}^{}}_{Mtx} )}{1 - {ϕ}_{Lim}^{app .} ( {{M}^{}}_{Mtx} )}$$

with matrix dependence. This represents a general parametric expression for porosity, particularly suited to situations where matrix mineralogy is known a priori, e.g., when it is available from elemental capture spectroscopy measurements. Where the matrix is not known a priori, and is to be worked out at the same time that we solve for the porosity φ, we may also proceed as follows:

$$[ \begin{matrix}ϕ \\ {V}_{{Min}_{A}}^{i} \\ … \\ {V}_{{Min}_{I}}^{i} \\ {V}_{{Min}_{J}}^{i} \\ … \\ {V}_{{Min}_{Z}}^{i}\end{matrix} ] = [ {[ {}^{T} Q \cdot {( K \cdot {Cov}_{{M}^{}} \cdot {}^{T} K )}^{- 1} \cdot Q ]}^{- 1} \cdot {}^{T} Q \cdot {( K \cdot {Cov}_{{M}^{}} \cdot {}^{T} K )}^{- 1} ] \cdot [ \begin{matrix}{{M}^{}}^{i} \\ 1\end{matrix} ]$$

where Q is now the matrix:

$$[ \begin{matrix}K ( {{M}^{}}_{ϕ} ) & K ( {{M}^{}}_{{Min}_{A}} ) & … & K ( {{M}^{}}_{{Min}_{I}} ) & K ( {{M}^{}}_{{Min}_{J}} ) & … & K ( {{M}^{}}_{{Min}_{Z}} ) \\ 1 & 1 & … & 1 & 1 & … & 1\end{matrix} ]$$

which is similarly totally independent of fluid type.

If we chose to focus primarily on the porosity φ, one may seek a further affine transformation represented as B(A(\vec{M}))=L(A(\vec{M}))+\vec{V} (with L (A(\vec{M})) being a linear transformation, and \vec{V} a constant vector), such that the constituents making-up the matrix (typically minerals) have the exact same response, this may be expressed mathematically as:

∀Min_{I},Min_{J}B(A(\vec{M}_{Min}_{_{J}}))=B(A(\vec{M}_{Min}_{_{I}}))

which would then result in the expression:

B(A(\vec{M}ⁱ)=φ·B(A(\vec{M}_{φ}))+(1−φ)·B(A(\vec{M}_{Mtx}))

or

L(K(\vec{M}ⁱ))=φ·L(K(\vec{M}_{φ}))+(1−φ)·L(K(\vec{M}_{Mtx}))

where Mtx is the matrix, and B(A(\vec{M}_{Mtx})) or L(K(\vec{M}_{Mtx})) now refers to a generic matrix constituent response.

This expression generalizes porosity expressions from scalar to vector form, while making it independent of both fluid type and mineral type, in the sense that any fluid point may be substituted for \vec{M}_{φ}, and any mineral point may be substituted for \vec{M}_{Mtx}, and the result remains the same because of the way the transformations A and B were designed. Similar to what was described earlier, the correct porosity φ may be solved in various ways, as:

$$\begin{matrix}{ϕ}_{α} = \frac{{( B ( A ( {{M}^{}}^{i} ) ) )}_{α} - {( B ( A ( {{M}^{}}_{Mtx} ) ) )}_{α}}{{( B ( A ( {{M}^{}}_{ϕ} ) ) )}_{α} - {( B ( A ( {{M}^{}}_{Mtx} ) ) )}_{α}} \\ = \frac{{( L ( K ( {{M}^{}}^{i} ) ) )}_{α} - {( L ( K ( {{M}^{}}_{Mtx} ) ) )}_{α}}{{( L ( K ( {{M}^{}}_{ϕ} ) ) )}_{α} - {( L ( K ( {{M}^{}}_{Mtx} ) ) )}_{α}}\end{matrix}$$

depending on the component a of the vector and B(A(\vec{M}_{Mtx})) or L(K(\vec{M})), used to solve for φ. A representative porosity φ would result from:

$$ϕ = [ {{[}^{T} ( LK ( {{M}^{}}_{ϕ} - {{M}^{}}_{Mtx} ) ) \cdot {( ( LK ) \cdot {Cov}_{{M}^{}} \cdot {}^{T} ( LK ) )}^{- 1} \cdot ( LK ( {{M}^{}}_{ϕ} - {{M}^{}}_{Mts} ) ) ]}^{- 1} \cdot {}^{T} ( LK ( {{M}^{}}_{ϕ} - {{M}^{}}_{Mtx} ) ) \cdot {( ( LK ) \cdot {Cov}_{{M}^{}} \cdot {}^{T} ( LK ) )}^{- 1} ] \cdot ( LK ( {{M}^{}}^{i} - {{M}^{}}_{Mtx} ) )$$

Although the above equation for the porosity φ is used to compute porosity in case of an over-determined system of equations, other approximations are again possible. It should be noted that the porosity shown in the equations above, and computed from the snapshot \vec{M}ⁱ, was not referred to as φⁱ, but just as φ (i.e., without the “i”), because the porosity is expected to remain the same irrespective of the \vec{M}ⁱ used. Moreover, using the different snapshots \vec{M}ⁱ available, then:
the different φⁱ may be compared amongst each other, to check that they are similar (for validation purposes);
they may also be compared among one another, to achieve a better depth matching in between the different snapshots;
the retained most representative porosity φ, may be the average of the φⁱ from the different snapshots; and
the statistical deviation in-between the different φⁱ may be used to assess and assign an uncertainty or error bar to that most representative porosity φ.

It should also be noted that consonant measurements m₁ m₂ . . . m_{α} m_{β} . . . mₙ, have been stipulated, and the different equations shown above assumed measurements with linear mixing laws. However, the present approach may be used even when the measurements are not consonant, or the mixing laws are not linear. In such case, the computed porosity φ may not be as accurate, although the statistical deviation in between the different φⁱ may embody or reflect the potential imperfections of non-consonance and/or non-linearity.

Henceforth, the challenge of computing the correct porosity φ, has now been morphed or shifted into the task of picking appropriate transformations A and B. The picks for A and B, meeting the desired conditions replicated below:

∀Fld_{I},Fld_{J}A(\vec{M}_{Fld}_{_{J}})=A(\vec{M}_{Fld}_{_{I}})

∀Min_{I},Min_{J}B(A(\vec{M}_{Min}_{_{J}}))=B(A(\vec{M}_{Min}_{_{I}}))

are projections. More specifically, if we denote by P_{(X,Y)} the projections parallel to subspace X and onto subspace Y, then A and B may be selected as follows:

$$A = {P}_{( {X}_{ϕ} , \overline{{X}_{ϕ}} )}$$

$$B = {P}_{( A ( {X}_{Mtx} ) , \overline{A ( {X}_{Mtx} )} )}$$

where X_{φ} is the subspace spanned by the constituents filling up the porosity (i.e., the fluids), and X̅_̅{̅φ̅}̅ is a complementary subspace (of dimension n−dim(X_{φ})) that is not parallel to X_{φ}. Likewise, A (X_{Mtx}) is the subspace spanned by the A-image of the constituents making up the matrix (i.e., the minerals), and A̅(̅X̅_̅{̅M̅t̅x̅}̅)̅ is a complementary subspace (of dimension n−dim(A(X_{Mtx}))) that is not parallel to A(X_{Mtx}). By way of example, the subspace spanned by a single fluid will be just a dot of dimension 0 (and not requiring any projection of any sort), the subspace spanned by two fluids will be a line of dimension 1, the subspace spanned by three fluids will be a plane of dimension 2, etc.

Different variations and embodiments of the above-described technique are possible. For example, techniques described herein may be applicable to situations which involve formation constituents with unknown characteristics. Measurements involved that change in between different snapshots, either as a result of mud-filtrate invasion alone, or invasion coupled with chemical reactions (including changes in composition and/or phase), or any other cause, may be corrected using these techniques. Examples of such situations may include applications to gas-bearing formations, applications to K-Formate mud filtrate invasion, salt dissolution coupled with WBM filtrate invasion (in case of salt-plugged formations). With respect to measurements, they may be used as is, normalized in various ways, or converted into apparent porosities, for example, using a hypothetical fluid and matrix types.

The dimension of the subspace X_{φ} may be available from, or may benefit from, a priori knowledge such as mud-logging data. The porosity constituents that span the subspace X_{φ} may include the sum of constituents that are “immovable” (i.e., remain unchanged in between different snapshots), and constituents that are “modifiable” (i.e., which undergo change in between different snapshots).

The dimension of the subspace X_{φ} is the sum of the number of constituents that are immovable, plus the number of constituents that are modifiable, less 1. The number of modifiable constituents may be known in advance, or it may be determined using statistical techniques such as Principal Component Analysis (PCA), as one plus the rank of the correlation matrix (i.e., the matrix correlating changes in measurements in between snapshots among each other). The number and log characteristics of the constituents that are immovable may be available beforehand.

Furthermore, the orientation (i.e. the vector subspace) of the subspace spanned by the modifiable constituents (including the unknown modifiable constituents), may be determined thru time-lapse analysis, or thru comparison vs. other ground truth like core data for example. In the case of time-lapse analysis, statistical analysis techniques such as PCA may be used to directly determine such vector subspace. However, a range of other statistical analysis techniques are also possible.

Indirect techniques may also be used, such as expressing an apparent porosity as a parametric combination of log measurements, which may then produce the same result irrespective of the snapshot considered. This may be constrained to read 1 (i.e., 100 pu) whenever the log measurements of the known porosity constituents are substituted in the parametric equations. The parameters that allow this to happen are then uniquely related to the orientation sought.

Pseudo normalization of the unknown modifiable constituents may be sufficient to proceed if trying to arrive at the porosity of the underground formation. In the case of comparison vs. other ground truth like core data, for example, one indirect technique would be to again express an apparent porosity as a parametric combination of log measurements, which may match the porosity data measured on cores, and constrained to read 1 (i.e. 100 pu) whenever the log measurements of the known porosity constituents are substituted in the parametric equations. Here again, the parameters that allow this to happen are then uniquely related to the orientation sought.

The subspace X_{φ} is uniquely defined as the subspace containing the known porosity constituents, as well as the vector subspace defined by the modifiable constituents. When the true matrix is known beforehand, the correct porosity may be estimated directly. When the matrix is not known, then either there are enough measurements available to solve simultaneously for the matrix and the porosity, or to carry-out a projection on the matrix minerals subspace A(X_{Mtx}), or an apparent porosity is used assuming a hypothetical prevalent or predominant matrix type.

Working with pseudo-normalized constituent responses may allow computation of the porosity using the traditional expression:

$$[ \begin{matrix}{V}_{A}^{i} \\ {V}_{B}^{i} \\ … \\ {V}_{I}^{i} \\ {V}_{J}^{i} \\ … \\ {V}_{Z}^{i}\end{matrix} ] = [ {[ {}^{T} R \cdot {Cov}^{- 1} \cdot R ]}^{- 1} \cdot {}^{T} R \cdot {Cov}^{- 1} ] \cdot [ \begin{matrix}{{M}^{}}^{i} \\ 1\end{matrix} ]$$

where we would solve first for the V_{I}ⁱ's, and then reconstruct the porosity second as:

$$ϕ = {\sum }_{I ∈ ϕ} {V}_{{Fld}_{I}}^{i}$$

It should be noted, however, that such computed V_{I}ⁱ's may be incorrect, and yet the corresponding sum leading to the porosity φ may still be correct. This is because the exact position of the porosity constituents on the porosity subspace is immaterial as far as the location of the porosity subspace is concerned, but other volumetric results will be incorrect when taken individually.

The complementary subspaces X̅_̅{̅φ̅}̅ and A̅(̅X̅_̅{̅M̅t̅x̅}̅)̅ may be selected in a number of ways, although X̅_̅{̅φ̅}̅ may be the subspace spanned by the matrix minerals points plus one of the known fluid points, such as mud-filtrate (if known) or native formation water (in which case the water and matrix mineral points would not be affected by the projection A). Moreover, A̅(̅X̅_̅{̅M̅t̅x̅}̅)̅ may be the line joining one of the matrix minerals (e.g., the prevalent or predominant mineral present) and the water points.

When the \vec{M} system of equations is under-determined, then the volumes of either one of the porosity fluids constituents volume may not be able to be assessed, or one of the matrix mineral constituents volume may not be able to be assessed. In this case, an assessment of the apparent porosity that is fluid independent may be performed.

When the \vec{M} system of equations is precisely determined, then there may be no reason to invoke the covariance matrixes, as the solution is unique. When the \vec{M} system of equations is over-determined, then the solution is not unique and covariance matrixes may be used to assess an optimal solution. This may be done according to the techniques described herein. This may be described geometrically as seeking the intersection of subspaces that may not otherwise intersect. The following example has been included to describe this situation.

If there are two fluids, e.g., water and gas, if we consider the matrix to be known, e.g., limestone formation, and if there are three available measurements, such as neutron, density, and sigma measurements, then the system is over-determined. The \vec{M} space has three dimensions (neutron, density, and sigma). The X_{φ} subspace is the line joining the water and gas points, as determined thru time-lapse analysis, for example. The X̅_̅{̅φ̅}̅ subspace is taken to be a plane that includes the limestone and water points.

In theory, we would take an actual measurement point \vec{M}, project it onto the plane X̅_̅{̅φ̅}̅ parallel to the line X_{φ}, and read the correct porosity directly off the limestone/water line in a deterministic fashion. However, in practice the projection of \vec{M} (i.e. A(\vec{M})) will typically miss the limestone/water line, even if merely by a little, due to inherent measurements noise or statistical errors. Geometrically, the question then becomes, to find the most representative point on the limestone/water line, where the projection of \vec{M} would have fallen, had the measurements been theoretically noise free. Moreover, although covariance matrixes may be invoked to do this, one way to expedite the process may be to instead seek that point on the limestone/water line that is “closest” to the line passing by \vec{M} and A(\vec{M}), leading to:

$$ϕ \approx \frac{\vert \begin{matrix}\begin{matrix}{}^{T} ( {M}^{} - {{M}^{}}_{Lim} ) \cdot ( {{M}^{}}_{Wat} - {{M}^{}}_{Lim} ) \\ {}^{T} ( {M}^{} - {{M}^{}}_{Lim} ) \cdot ( {{M}^{}}_{Wat} - {{M}^{}}_{Gas} )\end{matrix} \\ \begin{matrix}{}^{T} ( {{M}^{}}_{Wat} - {{M}^{}}_{Lim} ) \cdot ( {{M}^{}}_{Wat} - {{M}^{}}_{Gas} ) \\ {}^{T} ( {{M}^{}}_{Wat} - {{M}^{}}_{Gas} ) \cdot ( {{M}^{}}_{Wat} - {{M}^{}}_{Gas} )\end{matrix}\end{matrix} \vert}{\vert \begin{matrix}\begin{matrix}{}^{T} ( {{M}^{}}_{Wat} - {{M}^{}}_{Lim} ) \cdot ( {{M}^{}}_{Wat} - {{M}^{}}_{Lim} ) \\ {}^{T} ( {{M}^{}}_{Wat} - {{M}^{}}_{Lim} ) \cdot ( {{M}^{}}_{Wat} - {{M}^{}}_{Gas} )\end{matrix} \\ \begin{matrix}{}^{T} ( {{M}^{}}_{Wat} - {{M}^{}}_{Lim} ) \cdot ( {{M}^{}}_{Wat} - {{M}^{}}_{Gas} ) \\ {}^{T} ( {{M}^{}}_{Wat} - {{M}^{}}_{Gas} ) \cdot ( {{M}^{}}_{Wat} - {{M}^{}}_{Gas} )\end{matrix}\end{matrix} \vert}$$

When the \vec{M} system of equations is determined or over-determined, the relevant subspaces have been determined thru time-lapse analysis, and the transformations A and B are defined, then time-lapse data acquisition may no longer be called for, and the same transformations A and B may be used on offset wells, or at the level of the reservoir irrespective of well location in the field. However, it may also be possible that too many fluid types or variations in fluid characteristics across the field vs. a limited number of measurements in practice would not allow for a standardized and universal porosity formula across the field. In this case, time-lapse data acquisition may continue to be used on each well, and the subspace X_{φ} in particular may be re-oriented continuously zone-by-zone, or over a sliding window along the well to circumvent and overcome the lack of sufficient measurements to assign an overarching X_{φ}, in what would have been an \vec{M} space with more dimensions. Therefore, time-lapse data acquisition may allow for systematically assessing a correct porosity, even where traditional single-pass formation evaluation techniques would have considered the \vec{M} system of equations under-determined and not able to be solved.

FIGS. 8A-8C show non-consonant gamma-ray/neutron/density measurements time-lapse datasets, respectively, in a case of K-formate WBM filtrate invasion in a gas-bearing shaly sandstone formation. Original curves 210, 211; 220, 221; and 230, 231 are respectively from drill and wipe datasets. They show a shift in readings in between the drill and wipe passes (gamma-ray/neutron/density measurements read higher). Projected curves 212, 213; 222, 223; and 232, 233 are respectively from the drill and wipe datasets (note: in the figures, an axis on the left hand side is associated with the projected curves in the respective rectangular boundary). The projected curves 212, 213; 222, 223; and 232, 233 now overlay most of the time, as expected. However, the projected curves do not directly correspond to gamma-ray, neutron, or density, and they are not assigned precise measurement units. This is because they are “hybrid” measurements, including a “custom-designed” mixture of the original gamma-ray/neutron/density measurements, in such a manner to suppress the adverse effects of filtrate displacing gas, yet without resorting to a full and cumbersome characterization of the K-formate filtrate exact response \vec{M}_{K-formate filtrate}. These projected curves 212, 213; 222, 223; and 232, 233 may then be used instead of the original ones, and together with separate other measurements not affected by invasion, to proceed with the volumetric log interpretation.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A method for determining at least one characteristic of a geological formation having a borehole therein, the method comprising:
collecting first and second dataset snapshots of the geological formation from the borehole, each of the first and second dataset snapshots comprising measurement data for a plurality of different measurement types;
generating a differential dataset based upon the first and second dataset snapshots;
determining a multi-dimensional space based upon the differential dataset;
generating a first hybrid dataset based upon the first dataset snapshot by projecting the measurement data from the first dataset snapshot parallel to the multi-dimensional space and onto a complementary multi-dimensional space not parallel to the multi-dimensional space;
generating a second hybrid dataset based upon the second dataset snapshot by projecting the measurement data from the second dataset snapshot parallel to the multi-dimensional space and onto the complementary multi-dimensional space; and
determining at least one characteristic associated with the geological formation based upon the first and second hybrid datasets.

2. The method of claim 1 wherein determining the multi-dimensional space further comprises processing the differential dataset to determine a dimensionality of a corresponding vector space associated with at least one constituent material substituted between the first and second dataset snapshots, and determining the multi-dimensional space based upon the determined dimensionality of the corresponding vector space.

3. The method of claim 1 further comprising determining an average of the first and second hybrid datasets; and wherein determining the at least one characteristic associated with the geological formation further comprises determining the at least one characteristic based upon the average of the first and second hybrid datasets.

4. The method of claim 1 further comprising determining differences between the first and second hybrid log datasets and performing a statistical analysis based upon the differences to determine an error range associated with the hybrid log datasets.

5. The method of claim 1 wherein determining the multi-dimensional space comprises determining the multi-dimensional space based upon a principal component analysis (PCA).

6. The method of claim 1 wherein the at least one characteristic comprises porosity.

7. The method of claim 1 wherein the plurality of different measurement types comprises at least some of gamma-ray measurements, density measurements, neutron porosity measurements, sigma thermal neutron capture cross-section measurements, and nuclear magnetic resonance measurements.

8. The method of claim 1 wherein collecting the first and second dataset snapshots of the geological formation from the borehole comprises collecting the first and second dataset snapshots at different radial depths of investigation with respect to the borehole.

9. The method of claim 1 wherein collecting the first and second dataset snapshots of the geological formation from the borehole comprises collecting the first and second dataset snapshots at a given radial depth relative to the borehole at different times.

10. A well-logging system comprising:
a well-logging tool to collect first and second dataset snapshots of a geological formation from a borehole therein, each of the first and second dataset snapshots comprising measurement data for a plurality of different measurement types; and
a processor to
generate a differential dataset based upon the first and second dataset snapshots,
determine a multi-dimensional space based upon the differential dataset,
generate a first hybrid dataset based upon the first dataset snapshot by projecting the measurement data from the first dataset snapshot parallel to the multi-dimensional space and onto a complementary multi-dimensional space not parallel to the multi-dimensional space,
generate a second hybrid dataset based upon the second dataset snapshot by projecting the measurement data from the second dataset snapshot parallel to the multi-dimensional space and onto the complementary multi-dimensional space, and
determine at least one characteristic associated with the geological formation based upon the first and second hybrid datasets.

11. The well-logging system of claim 10 wherein said processor determines the multi-dimensional space by processing the differential dataset to determine a dimensionality of a corresponding vector space associated with at least one constituent material substituted between the first and second dataset snapshots, and determines the multi-dimensional space based upon the determined dimensionality of the corresponding vector space.

12. The well-logging system of claim 10 wherein said processor determines an average of the first and second hybrid datasets, and determines the at least one characteristic associated with the geological formation based upon the average of the first and second hybrid datasets.

13. The well-logging system of claim 10 wherein said processor determines differences between the first and second hybrid log datasets and performs a statistical analysis based upon the differences to determine an error range associated with the hybrid log datasets.

14. The well-logging system of claim 10 wherein said processor determines the multi-dimensional space based upon a principal component analysis (PCA).

15. The well-logging system of claim 10 wherein the at least one characteristic comprises porosity.

16. The well-logging system of claim 10 wherein the plurality of different measurement types comprises at least some of gamma-ray measurements, density measurements, neutron porosity measurements, sigma thermal neutron capture cross-section measurements, and nuclear magnetic resonance measurements.

17. The well-logging system of claim 10 wherein said processor collects the first and second dataset snapshots of the geological formation from the borehole at different radial depths of investigation with respect to the borehole.

18. The well-logging system of claim 10 wherein said processor collects the first and second dataset snapshots of the geological formation from the borehole at a given radial depth relative to the borehole at different times.

19. A non-transitory computer-readable medium having computer executable instructions for causing a computer to:
generate a differential dataset based upon first and second dataset snapshots of a geological formation, each of the first and second dataset snapshots comprising measurement data for a plurality of different measurement types;
determine a multi-dimensional space based upon the differential dataset;
generate a first hybrid dataset based upon the first dataset snapshot by projecting the measurement data from the first dataset snapshot parallel to the multi-dimensional space and onto a complementary multi-dimensional space not parallel to the multi-dimensional space;
generate a second hybrid dataset based upon the second dataset snapshot by projecting the measurement data from the second dataset snapshot parallel to the multi-dimensional space and onto the complementary multi-dimensional space; and
determine at least one characteristic associated with the geological formation based upon the first and second hybrid datasets.

20. The non-transitory computer-readable medium of claim 19 wherein the multi-dimensional space is determined by processing the differential dataset to determine a dimensionality of a corresponding vector space associated with at least one constituent material substituted between the first and second dataset snapshots, and determining the multi-dimensional space based upon the determined dimensionality of the corresponding vector space.

21. The non-transitory computer-readable medium of claim 19 wherein the at least one characteristic associated with the geological formation is determined based upon an average of the first and second hybrid datasets.

22. The non-transitory computer-readable medium of claim 19 further having computer-executable instructions for causing the computer to determine differences between the first and second hybrid log data points and perform a statistical analysis based upon the differences to determine an error range associated with the hybrid log data points.

23. The non-transitory computer-readable medium of claim 19 wherein the multi-dimensional space is determined based upon a principal component analysis (PCA).
